(19) United States
(12) Patent Application Publication
(10) Pub. No.: US 2024/0212020 A1
(43) Pub. Date: Jun. 27, 2024

(54) RECOMMENDATION SYSTEM, RECOMMENDATION METHOD, AND RECORDING MEDIUM

(71) Applicant: NEC Corporation, Tokyo (JP)

(72) Inventor: Katsufumi TANAKA, Tokyo (JP)

(73) Assignee: NEC Corporation, Tokyo (JP)

(21) Appl. No.: 18/543,273

(22) Filed: Dec. 18, 2023

(30) Foreign Application Priority Data
Dec. 23, 2022 (JP) 2022-207343

(51) Int. Cl. G06Q 30/0601; G06Q 50/16

(52) U.S. Cl. CPC G06Q 30/0631; G06Q 50/16

(57) ABSTRACT

A recommendation system includes: at least one memory configured to store instructions; and at least one processor configured to execute the instructions to: estimate a change, from a multi-person household to a single-person household, in a customer who is a member based on at least one of a product purchase history of the customer and communication information between a delivery person or a salesperson and the customer; extract a recommended community for single-person households from a plurality of communities for the members based on at least one of community information including information indicating an attribute of the community for each of the plurality of communities for the members and an estimation result of a change, to a single-person household, in another customer; and present the extracted recommended community.

This application is based upon and claims the benefit of priority from Japanese Patent Application No. 2022-207343, filed on Dec. 23, 2022, the disclosure of which is incorporated herein in its entirety by reference.

### TECHNICAL FIELD

The present disclosure relates to a recommendation system and the like.

### BACKGROUND ART

There is a technique for managing health of a user. For example, PTL 1 (JP 2013-109618 A) describes acquisition of basic information with health information and content with health information of another user relatively close to a health state of the user.

### SUMMARY

An object of the present disclosure is to provide a recommendation system or the like for suppressing isolation of a person living alone.

A recommendation system according to an aspect of the present disclosure includes: at least one memory configured to store instructions: and at least one processor configured to execute the instructions to: estimate a change, from a multi-person household to a single-person household, in a customer who is a member based on at least one of a product purchase history of the customer and communication information between a delivery person or a salesperson and the customer; extract a recommended community for single-person households from a plurality of communities for the members based on at least one of community information including information indicating an attribute of the community for each of the plurality of communities for the members and an estimation result of a change, to a single-person household, in another customer; and present the extracted recommended community.

A recommendation method according to an aspect of the present disclosure includes estimating a change, from a multi-person household to a single-person household, in a customer who is a member based on at least one of a product purchase history of the customer and communication information between a delivery person or a salesperson and the customer, extracting a recommended community for single-person households from a plurality of communities for the members based on at least one of community information including information indicating an attribute of the community for each of the plurality of communities for the members and an estimation result of a change, to a single-person household, in another customer, and presenting the extracted recommended community.

A program according to an aspect of the present disclosure causes a computer to execute processes including estimating a change, from a multi-person household to a single-person household, in a customer who is a member based on at least one of a product purchase history of the customer and communication information between a delivery person or a salesperson and the customer, extracting a recommended community for single-person households from a plurality of communities for the members based on at least one of community information including information indicating an attribute of the community for each of the plurality of communities for the members and an estimation result of a change, to a single-person household, in another customer, and presenting the extracted recommended community.

Each program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration example of a recommendation system according to a present disclosure:

FIG. 2 is an explanatory diagram illustrating a flow of the recommendation system:

FIG. 3 is a flowchart illustrating an operation example of the recommendation system according to the present disclosure;

FIG. 4 is an explanatory diagram illustrating an example of connection between the recommendation system and a terminal device:

FIG. 5 is a block diagram illustrating a configuration example of the recommendation system according to the present disclosure:

FIG. 6 is an explanatory diagram illustrating an example of presenting a recommended community:

FIG. 7 is a flowchart illustrating an operation example of the recommendation system according to the present disclosure; and

FIG. 8 is an explanatory diagram illustrating a hardware configuration example of a computer.

### EXAMPLE EMBODIMENT

Hereinafter, example embodiments of a recommendation system, a recommendation method, a program, and a non-transitory recording medium storing the program according to the present disclosure will be described in detail with reference to the drawings. The example embodiments do not limit the disclosed technology.

### First Example Embodiment

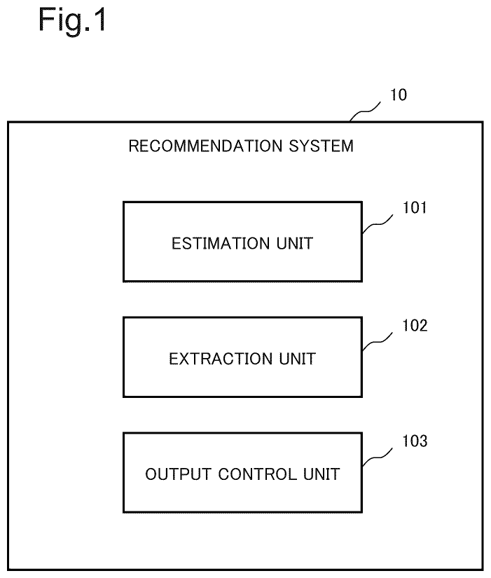

First, in the first example embodiment, a basic function of the recommendation system will be described. FIG. 1 is a block diagram illustrating a configuration example of the recommendation system according to the present disclosure. A recommendation system 10 is, for example, a system of a company that provides a service for members. Examples of the service for members include a service of selling a product via the Internet, a service of selling a product at a store, a service of delivering a product to a customer's home by a delivery person, a service of providing a community, and the like. The recommendation system 10 recommends a community to a customer who has become a single-person household. In FIG. 1, the recommendation system 10 includes an estimation unit 101, an extraction unit 102, and an output control unit 103.

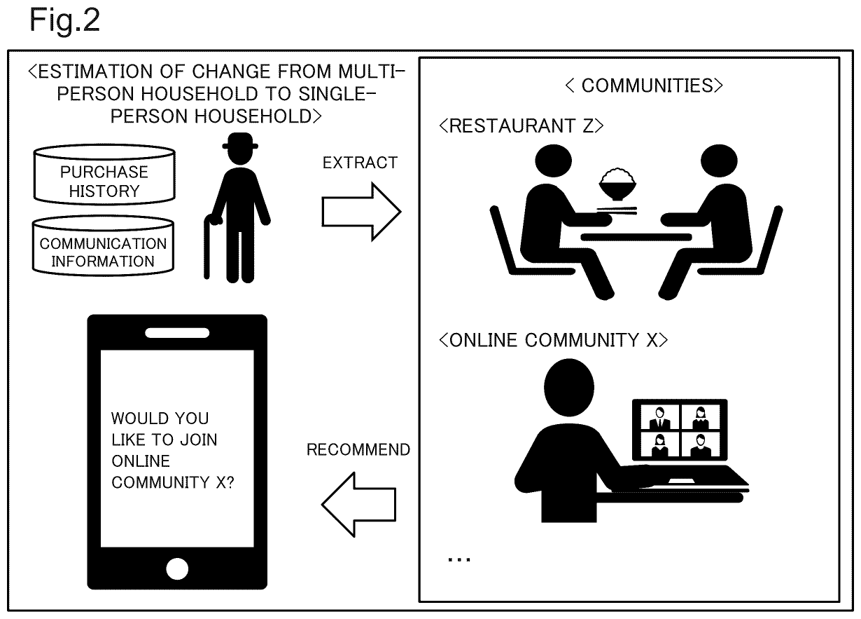

FIG. 2 is an explanatory diagram illustrating a flow of the recommendation system 10. The estimation unit 101 estimates a customer who has newly changed from a multi-person household to a single-person household. Then, the extraction unit 102 extracts a recommended community for single-person households from a plurality of communities. Then, the output control unit 103 presents the extracted recommended community.

Each functional unit will be described in detail.

The estimation unit 101 estimates a change in a customer from a multi-person household to a single-person household based on at least one of purchase history of products purchased by the customer and communication information between delivery persons or salespersons and the customer. Here, the multi-person household is a household of two or more people. For example, the product includes at least one of food, daily necessities, and cosmetics. For example, the delivery person delivers the product purchased by the customer to the customer's home. For example, the salesperson may be a store clerk of an actual store or a store clerk of an online store.

The customer's purchasing method may be purchasing at an actual store, or may be purchasing by an online order or a written order. For example, the estimation unit 101 may estimate the change from the multi-person household to the single-person household by estimating whether the amount of the product has changed from the amount for the family to the amount for one person based on the purchase history. For example, the estimation unit 101 may estimate the change from a multi-person household to a single-person household by estimating whether the number of times of purchasing ready-made products has increased based on the purchase history. The estimation unit 101 estimates that the multi-person household has changed to a single-person household when the number of times of purchasing those ready-made products increases. In addition, for example, there is a person who tends to stay at home in a case where the person unexpectedly becomes a single-person household due to a death of a family member. When the user refrains from going out, cosmetics may not be purchased or clothing items may not be purchased. As described above, for example, a change appears in purchase of clothing items and cosmetics. Therefore, for example, the estimation unit 101 may estimate a change from a multi-person household to a single-person household by estimating a change from an outing tendency to an at-home tendency from a purchase history of clothing items or the like.

Furthermore, the estimation unit 101 may give the purchase history of the customer to a learning model, and predict whether the customer's shopping tendency approaches a shopping tendency of a single-person household from a shopping tendency of a multi-person household using the learning model. For example, the learning model is a model in which a shopping tendency of a multi-person household and a shopping tendency of a single-person household are learned in advance based on the purchase histories of a plurality of customers.

In addition, the communication information between the delivery person or the salesperson and the customer may be communication information through a call record, a communication record, and the like which are not actual face-to-face communication with the customer. Furthermore, the communication information may be communication information at the time of actual face-to-face communication. The communication information may be, for example, information in which communication between the delivery person or the salesperson and the customer is recorded by an operation of the delivery person or the salesperson via a terminal device. For example, the delivery person or the salesperson may input the information of the communication with the customer in a form of a memo to the terminal device. The communication information may be, for example, information in which the communication between the delivery person or the salesperson and the customer is recorded by a voice recorder. Then, the estimation unit 101 estimates a change from a multi-person household to a single-person household in the customer based on the communication information. Specifically, for example, the estimation unit 101 analyzes the communication information. The estimation unit 101 may estimate a change from a multi-person household to a single-person household by detecting information such as spousal bereavement, children's independence, and job relocation from the communication information. For example, the estimation unit 101 may estimate, from the communication information, a change from a communication tendency including words related to a multi-person household to a communication tendency including words related to a single-person household.

Note that those estimation methods may be used in combination.

The extraction unit 102 extracts a recommended community for single-person households from a plurality of communities based on at least one of community information of each of the plurality of communities for members and an estimation result of a change in another customer to a single-person household. The community information includes, for example, information indicating an attribute of the community. The attribute of the community may be a family structure targeted by the community, such as for families or persons living alone.

For example, the extraction unit 102 may extract, as the recommended community, a community whose community attribute included in the community information is for a person living alone based on the community information.

Furthermore, for example, the extraction unit 102 extracts a community in which at least some customers belonging to the community are customers who have been estimated to have changed from a family household to a single-person household based on estimation results of changes, to a single-person household, in other customers.

Note that those extraction methods may be used in combination.

The output control unit 103 presents the extracted community. As the presentation processing, for example, the output control unit 103 causes the terminal device to output the extracted community information of the community. The community information output here is, for example, a name of the community, a format of the community, or the like, and is not particularly limited. Examples of the output method include sound output and display output. For example, in FIG. 2, the output control unit 103 causes the terminal device to display information of the extracted recommended community.

### (Flowchart)

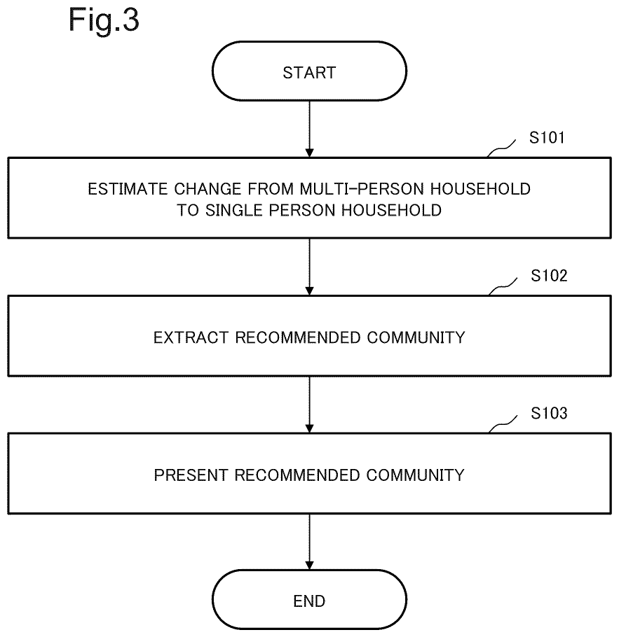

FIG. 3 is a flowchart illustrating an operation example of the recommendation system 10 according to the present disclosure. The estimation unit 101 estimates a change from a multi-person household to a single-person household of a customer (step S101). The extraction unit 102 extracts a recommended community for single-person households from the plurality of communities (step S102). The output control unit 103 presents the extracted recommended community (step S103), and the recommendation system 10 ends the processing.

As described above, according to the first example embodiment, the recommendation system 10 estimates the change in the customer from the multi-person household to the single-person household, extracts the recommended community for single-person households based on the content of the community for members or the estimation result of the single-person household regarding another customer, and presents the extracted recommended community to the customer. In this manner, by recommending the community to the customer who newly becomes a single-person household from a multi-person household, it is possible to suppress the isolation of the customer who lives alone. Therefore, health of the customer can be supported. It is particularly useful for customers such as elderly people who unexpectedly become a single-person household from a multi-person household. Furthermore, if the customer participates in the community, the health of the customer can be easily managed. As a result, the healthy life of the customer can be extended.

### Second Example Embodiment

Next, a second example embodiment will be described in detail with reference to the drawings. According to the second example embodiment, in order to recommend a community more suitable for the customer of a single-person household, the attribute of the customer is specified, and a recommended community is extracted based on the attribute of the customer. Hereinafter, description of contents same as the above description will be omitted to the extent that the description of the second example embodiment does not become unclear.

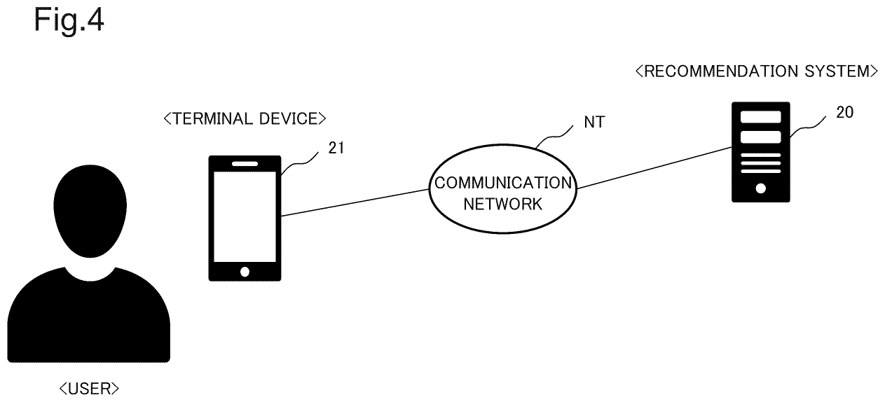

FIG. 4 is an explanatory diagram illustrating an example of connection between the recommendation system and the terminal device. For example, the recommendation system 20 receives an operation of the user or presents information to the user via a terminal device 21. Here, the user is a customer who is a member.

For example, an application program that can display information from the recommendation system 20 or can transmit information to the recommendation system 20 may be installed in the terminal device 21 in advance. Furthermore, the terminal device 21 may be capable of displaying information from the recommendation system 20 or transmitting information to the recommendation system 20 via a website.

For example, the recommendation system 20 is connected to the terminal device 21 via a communication network NT. The terminal device 21 may be the terminal device 21 of a user or the terminal device 21 of a store. The type of the terminal device 21 is not particularly limited, and may be a personal computer (PC), a smartphone, a tablet device, or the like. In FIG. 4, one communication network NT is exemplified for ease of description, but the recommendation system 20 may be connected by different communication networks NT for each terminal device 21, and is not particularly limited.

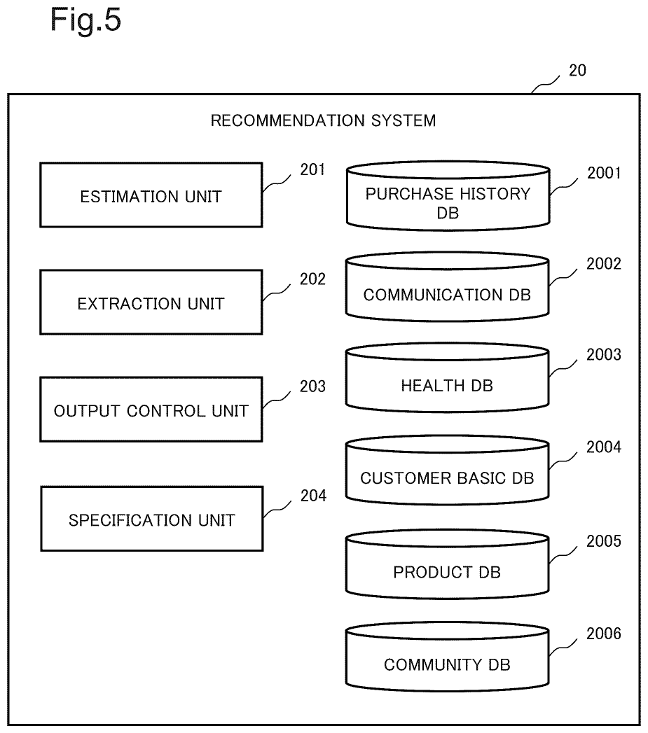

FIG. 5 is a block diagram illustrating a configuration example of the recommendation system 20 according to the present disclosure. The recommendation system 20 includes an estimation unit 201, an extraction unit 202, an output control unit 203, and a specification unit 204. In recommendation system 20, the specification unit 204 is further added to the recommendation system 10 according to the first example embodiment. The estimation unit 201 has, as a basic function, the function of the estimation unit 101 described in the first example embodiment. In addition, the extraction unit 202 has, as a basic function, the function of the extraction unit 102 described in the first example embodiment. The output control unit 203 has, as a basic function, the function of the output control unit 103 described in the first example embodiment.

In addition, the recommendation system 20 includes a purchase history DB 2001, a communication DB 2002, a health DB 2003, a customer basic DB 2004, a product DB 2005, and a community DB 2006.

The purchase history DB 2001 has a purchase history for each customer. The purchase history DB 2001 stores customer identification information for identifying a customer and a purchase history in association with each other. The purchase history includes product identification information for identifying a product purchased by a customer, a product name, a purchase quantity, a purchase price, and delivered or not.

The communication DB 2002 has communication information for each customer. The communication DB 2002 stores the customer identification information and the communication information in association with each other. The communication information is as described in the first example embodiment.

The health DB 2003 has health information for each customer. The health DB 2003 stores customer identification information and health information in association with each other. The health information includes, for example, symptoms and medical history of the customer. For example, the health information may be registered in advance by the customer, or may be a result of a health examination or the like.

The customer basic DB 2004 has customer information for each customer who is a member. The customer basic DB 2004 stores customer identification information for identifying the customer and customer information in association with each other. The customer information is information such as age, generation, gender, and address of the customer.

The product DB 2005 has product information for each product. The product DB 2005 stores the product identification information and the product information in association with each other. The product information may be a product name, a price of the product, a category of the product, an image of the product, or the like.

The community DB 2006 has, for each community, community information and customer identification information for identifying customers who participate in the community. The community DB 2006 stores community identification information for identifying communities, the community information, and the customer identification information of customers who participate in the community in association with each other. The community information includes information indicating attributes of the community, a format of the community, an operation time of the community, an address of the community in the case of the face-to-face community, and the like. The attribute of the community may be the age, generation, gender, or the like of the customer targeted by the community, or may be a family structure targeted by the community as described in the first example embodiment. The form of the community represents whether it is an online format or a face-to-face format in which the participants actually meet. The form of community may be a more detailed classification of the online format. More detailed classification of the online format includes an electronic bulletin board format, a social network service (SNS) format in which mutual interaction is performed online, an online meeting format, and the like. The format of community may be a more detailed classification of the face-to-face format. The more detailed classification of the face-to-face format may be, for example, a format in which participants can participate at any time at a restaurant or the like, or a workshop format in which participants work together.

Each functional unit will be described. The estimation unit 201 is the same as what is described in the first example embodiment, and thus a detailed description thereof will be omitted.

Next, the specification unit 204 specifies the attribute of the customer. The attribute of the customer is, for example, housework ability, conversation ability, activeness, hobby, exercise capacity, age, generation, gender, employed or unemployed, occupation, occupation type, residential area, regional characteristics of residential area, and the like. The activeness represents, for example, a degree of willingness to go outside. The regional characteristics of residential area may be, for example, an urban area or a suburb. The occupation type may be, for example, telework, office work, work in a factory, or the like. Here, a method of expressing each attribute is not particularly limited. For example, the level of housework ability, conversation ability, activeness, exercise capacity; and the like may be quantified so as to be comparable to a threshold value or the like. In this manner, since the level of each ability can be determined by a threshold or the like, detailed description thereof will be omitted below. Furthermore, for example, each capability may be expressed in ten levels and relatively comparable. Detailed description of the relative comparison of the abilities will be omitted below:

Specifically, for example, the specification unit 204 specifies the attribute of the customer from at least one of the purchase history and the communication information between the delivery person or the salesperson and the customer.

For example, the specification unit 204 specifies the housework ability as the attribute of the customer from the purchase history. For example, the specification unit 204 specifies that the housework ability is higher if purchasing ingredients more frequently, and specifies that the housework ability is lower if purchasing ready-made products more frequently, based on the purchase history after the change from the multi-person household to the single-person household. For example, the specification unit 204 specifies the activeness as the attribute of the customer from the purchase history. Based on the purchase history, if the purchase amount of cosmetics or the purchase amount of clothes is reduced, the specification unit 204 may specify that the user is often at home and the activeness is low: Furthermore, for example, the specification unit 204 may specify a hobby as an attribute of the customer from the purchase history. Furthermore, for example, the specification unit 204 may specify the occupation type as the attribute of the customer from the purchase history.

In addition, the specification unit 204 may specify, from the communication information, at least one of the activeness, exercise capacity, employed or unemployed, occupation, occupation type, age, generation, gender, regional characteristics, residential area, and conversation ability as the attribute of the customer. The specification unit 204 simply specifies words related to the activeness, exercise capacity, employed or unemployed, occupation, occupation type, age, generation, gender, regional characteristics, and residential area, and specify each attribute based on the specified words. Taking the activeness as an example, the specification unit 204 may specify a word related to the outing from the communication information and specify the activeness based on the outing frequency obtained from the word related to the outing. Taking the exercise capacity as an example, the specification unit 204 may specify a word related to the exercise from the communication information and specify the exercise capacity based on the word related to the exercise.

Furthermore, for example, the specification unit 204 may specify the frequency of conversation from the communication information and specify the conversation ability based on the frequency of conversation.

Here, the information of the attribute of the customer specified by the specification unit 204 may be stored in an attribute DB or the like that stores the attribute estimated for each customer.

In addition, the attribute of the customer such as age, generation, gender, residential area, employed or unemployed, occupation, and occupation type may be registered in advance by the customer. For example, the residential area or the like may be registered in a delivery DB in advance. In addition, the regional characteristics may be estimated from the residential area.

Next, the extraction unit 202 may extract a recommended community from the plurality of communities for members based on the identified attribute of the customer. For example, it is expected that a less active customer is less likely to participate in face-to-face format communities that they actually meet. On the other hand, it is expected that a customer with high activeness is highly likely to participate in a face-to-face format community. Therefore, the extraction unit 202 extracts an online format community as a recommended community for a customer with low activeness, and extracts a face-to-face format community as a recommended community for a customer with high activeness.

Specifically, for example, the extraction unit 202 extracts a community to which another customer having an attribute similar to that of the customer belongs as the recommended community.

Furthermore, for example, the extraction unit 202 may extract a recommended community from the plurality of communities based on the attribute of the customer and the attribute of the community. For example, if the attribute of the customer is a woman in her thirties, the extraction unit 202 extracts a community whose attribute is for women in their thirties as the recommended community.

Furthermore, for example, in a case where the attribute of the customer is the customer's housework ability and conversation ability, the extraction unit 202 extracts a community held at a restaurant from the plurality of communities in a case where the conversation ability is relatively higher than the housework ability. On the other hand, in a case where the housework ability is relatively higher than the conversation ability, the extraction unit 202 extracts an online format community from the plurality of communities. Here, the conversation ability and the housework ability may be quantified in advance in a relatively comparable manner.

In addition, for example, in a case where the attribute of the customer is the residential area of the customer or the regional characteristics of the residential area, the extraction unit 202 extracts a recommended community from the plurality of communities according to the ease of access to the community of the area in the residential area. More specifically, for example, the extraction unit 202 extracts the recommended community based on the number of communities in the residential area. For example, if there are many communities in the residential area, there is a high possibility that the customer can participate in the community in the residential area. On the other hand, if there are few communities in the residential area, the customer is less likely to be able to participate in the community in the residential area. Therefore, in a case where there are few communities in the residential area, the extraction unit 202 extracts an online format community as a recommended community. On the other hand, in a case where there are many communities in the residential area, the extraction unit 202 extracts a community held at a restaurant or a recreational community as a recommended community.

In addition, it is expected that in the suburb, there are many chances of face-to-face conversations actually met in the area, and in the urban area, there are few chances of actual conversations in the area. The extraction unit 202 extracts an online format community as a recommended community if the regional characteristics is a suburb, and extracts a community held at a restaurant or a recreational community as a recommended community if the regional characteristics is an urban area.

In addition, for example, as a service for the members, in some areas, a circuit bus is provided for transportation to stores or restaurants. In addition, for example, whether a customer can easily participate in a community differs depending on a distance from the customer's house to the place where the actual community is held. In particular, for example, if the customer's house is within a walking range, the customer can easily participate in the actual community. Whether it is within the walking range may be determined by age or generation. Therefore, for example, in a case where the attribute of the customer is the residential area of the customer, the extraction unit 202 may extract the recommended community based on the accessibility to the community for the members. When there is an actual community for the members at a location easily accessible by the customer, the extraction unit 202 may extract the community as a recommended community. Specifically, for example, the extraction unit 202 extracts the recommended community based on the distance from the residential area of the customer to the place where the community for the members is held. More specifically, when the distance from the residential area of the customer to the place where the community for the members is held is within a predetermined distance, the extraction unit 202 extracts the community as the recommended community: The predetermined distance may be a distance that can be moved on foot as described above, or may be determined by age. When the distance from the customer's home to the place where the community for the members is held is not within a predetermined distance, the extraction unit 202 extracts a community that can arrange a transportation means as a recommended community. On the other hand, in a case where there is no actual community for the members at locations where the customer can easily access, the extraction unit 202 may extract an online format community as the recommended community. For example, when the distance from the residential area of the customer to the place where the community for the members is held is not within a predetermined distance and there is no community for members for which a transportation means can be arranged, the extraction unit 202 extracts an online format community as the recommended community.

In addition, a person living alone such as an elderly person may have a problem such as illness. Therefore, the extraction unit 202 extracts, as a recommended community, a community to which other customers having at least one of a symptom and a medical history similar to each other belong from the plurality of communities based on the health information including the customer's symptom and medical history.

Note that the recommended community extraction methods may be used in combination.

As described in the first example embodiment, the output control unit 203 presents the recommended community to the customer. For example, the output control unit 203 may cause the terminal device 21 to display the name and attribute of the recommended community included in the community DB 2006. In addition, the output control unit 203 may display the recommendation message together.

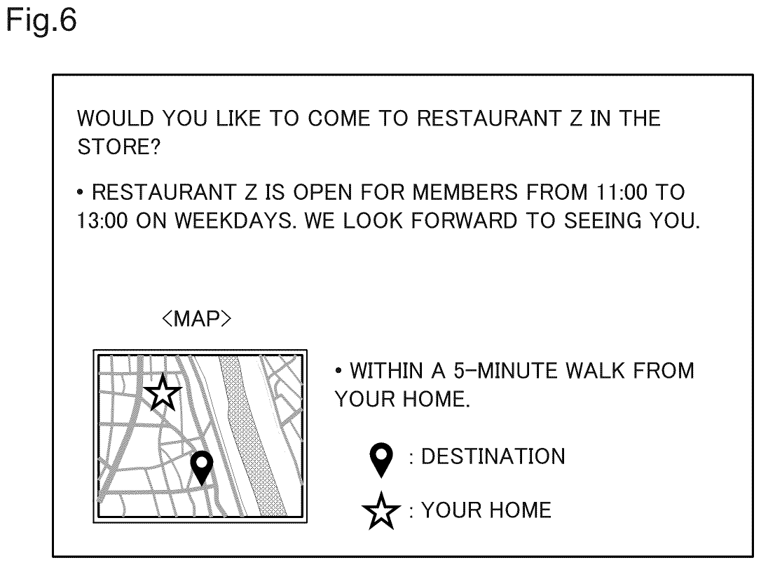

FIG. 6 is an explanatory diagram illustrating a presentation example of a recommended community. FIG. 6 illustrates a screen of the terminal device 21. In FIG. 6, on the screen, Restaurant room Z is recommended as the recommended community. In FIG. 6, map information is further displayed in addition to the name of the recommended community as the information of the recommended community on the screen. Furthermore, in FIG. 6, for example, the travel time from the customer's house to the recommended community in a case where the customer travels on foot is displayed on the screen.

In addition, a plurality of recommended communities may be extracted. In a case where a plurality of recommended communities is extracted, the output control unit 203 may present the recommended communities for each community format. Furthermore, the output control unit 203 may present the recommended community in order of distance from the customer's home.

Furthermore, the estimation unit 201 may detect a change from a multi-person household to a single-person household every predetermined period. In the above example, an example has been described in which a recommended community is presented to a customer estimated to have a change from a multi-person household to a single-person household. Furthermore, the estimation unit 201 may estimate a change from a single-person household to a multi-person household in a customer whose change to a single-person household had been estimated. The extraction unit 202 newly extracts a recommended community for multi-person households from the plurality of communities for the members. Then, the output control unit 203 presents the newly extracted recommended community.

### (Flowchart)

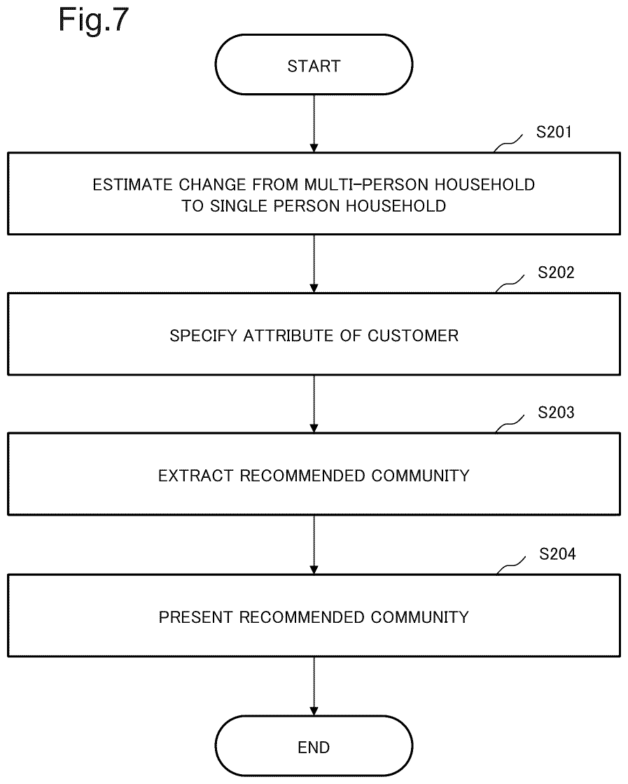

FIG. 7 is a flowchart illustrating an operation example of the recommendation system 20 according to the present disclosure. The estimation unit 201 estimates a change from a multi-person household to a single-person household (step S201). Next, the specification unit 204 specifies the attribute of the customer from at least one of the purchase history and the communication information between the delivery person or the salesperson and the customer (step S202).

Then, the extraction unit 202 extracts a recommended community based on the identified attribute of the customer (step S203). As described above, the method of extracting the recommended community based on the attribute of the customer is not particularly limited.

The output control unit 203 presents the extracted recommended community (step S204), and the recommendation system 20 ends the processing.

As described above, according to the second example embodiment, the recommendation system 20 specifies the attribute of the customer from at least one of the purchase history and the communication information, and extracts a recommended community from the plurality of communities based on the attribute of the customer. For example, the recommendation system 20 extracts, as a recommended community, a community to which another customer having an attribute similar to that of the customer belongs from the plurality of communities. Furthermore, for example, the recommendation system 20 extracts a recommended community from the plurality of communities based on the attribute of the customer and the format of the community. Furthermore, for example, the recommendation system 20 extracts a face-to-face format community as a recommended community in a case where the conversation ability is relatively higher than the housework ability, and extracts an online format community as a recommended community in a case where the housework ability is relatively higher than the conversation ability. The attribute of the customer is the residential area of the customer or the regional characteristics of the residential area, and the recommendation system 20 extracts a recommended community from the plurality of communities based on the ease of access to the community of the area in the residential area. In this manner, by extracting a community based on the attribute of the customer, it is possible to recommend a community more suitable for the customer.

In addition, as described above, there is a case where an elderly person or the like has a problem of illness. In view of this, the recommendation system 20 extracts, as a recommended community, a community to which other customers having at least one of a similar symptom or a similar medical history belong from the plurality of communities based on the health information including the customer's symptom and medical history. As a result, the customer can participate in a community presumed to have a common topic.

In addition, after becoming a single-person household from a multi-person household, the single-person household may return to a multi-person household. The recommendation system 20 may estimate a change, from a single-person household to a multi-person household, in the customer who was estimated to have changed to a single-person household, and newly extract and present a recommended community for multi-person households from the plurality of communities. With this configuration, a community suitable for the customer can be recommended when the type of household changes again.

Each of the example embodiments has been described. Each example embodiment may be modified, or may be used in combination as appropriate.

In addition, in each example embodiment, the recommendation systems 10 and 20 may be configured to include each functional unit and a part of information.

Each of the example embodiments is not limited to the examples described above, and various modifications can be made. The configurations of recommendation systems 10 and 20 according to the example embodiments are not particularly limited. For example, the recommendation systems 10 and 20 may be realized by one device such as one server. In a case where each functional unit of the recommendation systems 10 and 20 is realized by one device, for example, one device may be referred to as a recommendation device, an information processing device, or the like, and is not particularly limited. Alternatively, the recommendation systems 10 and 20 according to the example embodiments may be realized by different devices for each function or data. For example, each functional unit may be configured by a plurality of servers and implemented as a recommendation system. For example, the recommendation systems 10 and 20 may be realized by a database server including each database (DB) and a server including each functional unit.

In each example embodiment, each piece of information and each database may include a part of the information described above. Furthermore, each piece of information and each database may include information other than the above-described information. Each piece of information or each database may be divided into a plurality of databases or a plurality of pieces of information in more detail, or may be one database. For example, the purchase history DB 2001, the communication DB 2002, the health DB 2003, and the customer basic DB 2004 may be one customer DB. As described above, a method for implementing each piece of information and each database is not particularly limited.

Each screen is an example, and is not particularly limited. In each screen, a button, a list, a check box, an information display field, an input field, and the like (not illustrated) may be added. Furthermore, the background color of the screen and the like may be changed.

Furthermore, the processing of generating information or the like to be displayed on the terminal device may be performed by the output control unit 103, 203. Furthermore, this processing may be performed by the terminal device.

### (Hardware Configuration Example of Computer)

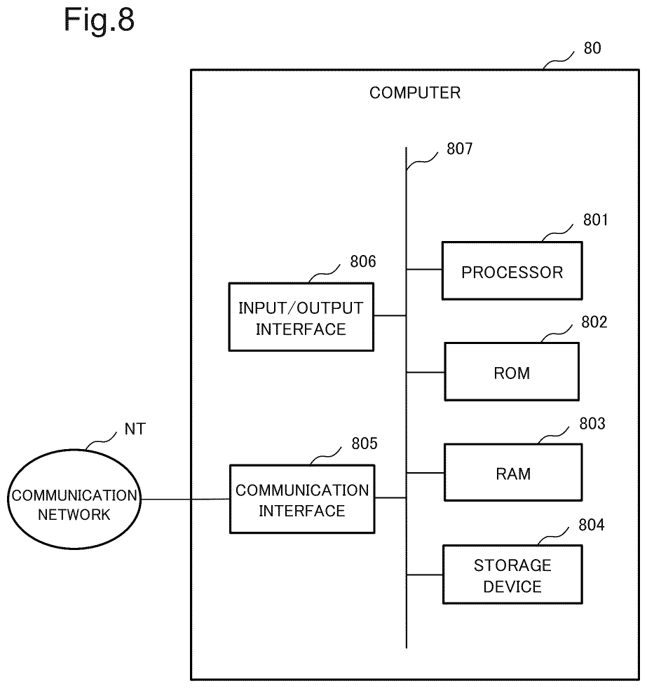

Next, a hardware configuration example in a case where each device such as the recommendation systems 10 and 20 and the terminal device 21 described in each example embodiment is realized by a computer will be described. FIG. 8 is an explanatory diagram illustrating a hardware configuration example of a computer. For example, a part or all of each device can be realized using any combination of a computer 80 and a program as illustrated in FIG. 8.

The computer 80 includes, for example, a processor 801, a read only memory (ROM) 802, a random access memory (RAM) 803, and a storage device 804. Furthermore, the computer 80 includes a communication interface 805 and an input/output interface 806. The components are connected via, for example, a bus 807. Note that the number of each component is not particularly limited, and each component is one or more.

The processor 801 controls the entire computer 80. As the processor 801, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a microcontroller, or a combination thereof can be used.

In addition, the computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801.

In addition, the processor 801 loads a program stored in the storage device 804, the ROM 802, or the like. Then, the processor 801 executes each process coded in the program. In addition, the processor 801 may download various programs via the communication network NT. In addition, the processor 801 functions as a part or all of the computer 80. Then, the processor 801 may execute processing or instructions in the illustrated flowchart based on the program.

The communication interface 805 is connected to the communication network NT such as a local area network (LAN) or a wide area network (WAN) through a wireless or wired communication line. Note that the communication network NT may include a plurality of communication networks NT. With such a configuration, the computer 80 is connected to an external device or an external computer 80 via the communication network NT. The communication interface 805 manages an interface between the communication network NT and the inside of the computer 80. Then, the communication interface 805 controls input and output of data from an external device or the external computer 80.

Furthermore, the input/output interface 806 is connected to at least one of an input device, an output device, and an input/output device. The connection method may be wireless or wired. Examples of the input device include a keyboard, a mouse, and a microphone. Examples of the output device include a display device, a lighting device, and a sound output device that outputs sound. Examples of the input/output device include a touch panel display. Note that the input device, the output device, the input/output device, and the like may be built in the computer 80 or may be externally attached.

The hardware configuration of the computer 80 is an example. The computer 80 may have some components illustrated in FIG. 8. The computer 80 may have components other than those illustrated in FIG. 8. For example, the computer 80 may include a drive device or the like. Then, the processor 801 may read a program or data stored in a recording medium attached to the drive device or the like into the RAM 803. Examples of the non-transitory tangible recording medium include an optical disk, a flexible disk, a magnetic optical disk, and a universal serial bus (USB) memory. Furthermore, as described above, for example, the computer 80 may include an input device such as a keyboard and a mouse. The computer 80 may have an output device such as a display. Furthermore, the computer 80 may include an input device, an output device, and an input/output device.

Furthermore, the computer 80 may include various sensors (not illustrated). The type of the sensor is not particularly limited. Furthermore, the computer 80 may include an imaging device capable of capturing images and videos.

The hardware configuration of each device has been described. In addition, there are various modification examples in a method of realizing each device. For example, each device may be achieved by any combination of a computer and a program different for each component. A plurality of components included in each device may be achieved by any combination of one computer and a program.

A part or all of each component of each device may be realized by an application specific circuit. A part or all of each component of each device may be realized by a general-purpose circuit including a processor such as a field programmable gate array (FPGA). In addition, some or all of the components of each device may be realized by a combination of an application specific circuit, a general-purpose circuit, or the like. In addition, these circuits may be a single integrated circuit. Alternatively, these circuits may be divided into a plurality of integrated circuits. The plurality of integrated circuits may be configured by being connected via a bus or the like.

In a case where some or all of the components of each device is achieved by a plurality of computers, circuits, and the like, the plurality of computers, circuits, and the like may be arranged in a centralized manner or in a distributed manner.

The recommendation methods described in the example embodiments are implemented by the recommendation systems 10 and 20. Furthermore, for example, the recommendation method is implemented by a computer such as a server or a terminal device executing a program prepared in advance.

The program described in each example embodiment is recorded in a computer-readable recording medium such as an HDD, an SSD, a flexible disk, an optical disk, a magnetic optical disk, and a USB memory. Then, the program is executed by being read from the recording medium by the computer. In addition, the program may be distributed via the communication network NT.

Each component of recommendation systems 10 and 20 in each example embodiment described above may be implemented by dedicated hardware such as a computer. Alternatively, each component may be realized by software. Alternatively, each component may be implemented by a combination of hardware and software.

It is desired to support health of a person living alone. For example, in a case where a person who is not originally a person living alone such as an elderly person who has started to live alone, the health condition may deteriorate due to isolation.

According to the present disclosure, it is possible to suppress isolation of a person living alone.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

A part or all of the above example embodiments can also be described as the following supplementary notes. However, some or all of the above example embodiments are not limited to the following.

### (Supplementary Note 1)

A recommendation system including
an estimation means that estimates a change, from a multi-person household to a single-person household, in a customer who is a member based on at least one of a product purchase history of the customer and communication information between a delivery person or a salesperson and the customer,
an extraction means that extracts a recommended community for single-person households from a plurality of communities based on at least one of community information including information indicating an attribute of the community for each of the plurality of communities for the members and an estimation result of a change, to a single-person household, in another customer, and
an output control means that presents the extracted recommended community.

### (Supplementary Note 2)

The recommendation system according to Supplementary Note 1 includes
a specification means that specifies an attribute of the customer based on at least one of the purchase history and the communication information, in which
the extraction means extracts the recommended community from the plurality of communities based on the attribute of the customer.

### (Supplementary Note 3)

The recommendation system according to Supplementary Note 2, in which
the extraction means extracts, from the plurality of communities, a community to which another customer having an attribute similar to the attribute of the customer belongs as the recommended community.

### (Supplementary Note 4)

The recommendation system according to Supplementary Note 2 or 3, in which
the community information includes information indicating a format of the community, and
the extraction means extracts the recommended community from the plurality of communities based on the attribute of the customer and the format of the community.

### (Supplementary Note 5)

The recommendation system according to any one of Supplementary Notes 2 to 4, in which
regarding housework ability and conversation ability of the customer in the attribute of the customer, the extraction means extracts a face-to-face format community from the plurality of communities as the recommended community in a case where the conversation ability is higher than the housework ability, and extracts an online format community from the plurality of communities as the recommended community in a case where the housework ability is higher than the conversation ability.

### (Supplementary Note 6)

The recommendation system according to any one of Supplementary Notes 2 to 5, in which
the attribute of the customer is a residential area of the customer or regional characteristics or the residential area, and
the extraction means extracts the recommended community from the plurality of communities based on ease of access to the community in a region of the residential area.

### (Supplementary Note 7)

The recommendation system according to any one of Supplementary Notes 1 to 6, in which
based on health information including a symptom and a medical history of the customer, the extraction means extracts a community to which another customer having at least one of a similar symptom and a similar medical history belongs as the recommended community from the plurality of communities.

### (Supplementary Note 8)

The recommendation system according to any one of Supplementary Notes 1 to 7, in which
the estimation means further estimates a change, from a single-person household to a multi-person household, in the customer who was estimated to have changed to a single-person household,
the extraction means newly extracts a recommended community for multi-person households from the plurality of communities, and
the output control means presents the newly extracted recommended community.

### (Supplementary Note 9)

The recommendation system according to any one of Supplementary Notes 1 to 8, in which
the product is at least one of food, daily necessities, and clothing items,
the delivery person delivers the product to the customer's home, and
the salesperson is a store clerk who sells the product.

### (Supplementary Note 10)

A recommendation method including
estimating a change, from a multi-person household to a single-person household, in a customer who is a member based on at least one of a product purchase history of the customer and communication information between a delivery person or a salesperson and the customer,
extracting a recommended community for single-person households from a plurality of communities for the members based on at least one of community information including information indicating an attribute of the community for each of the plurality of communities for the members and an estimation result of a change, to a single-person household, in another customer, and
presenting the extracted recommended community.

### (Supplementary Note 11)

The recommendation method according to Supplementary Note 10 includes
specifying an attribute of the customer based on at least one of the purchase history and the communication information, in which
the extraction means extracts the recommended community from the plurality of communities based on the attribute of the customer.

### (Supplementary Note 12)

The recommendation method according to Supplementary Note 11, in which
from the plurality of communities, a community to which another customer having an attribute similar to the attribute of the customer belongs is extracted as the recommended community.

### (Supplementary Note 13)

The recommendation method according to Supplementary Note 11 or 12, in which
the community information includes information indicating a format of the community, and
the recommended community is extracted from the plurality of communities based on the attribute of the customer and the format of the community.

### (Supplementary Note 14)

The recommendation method according to any one of Supplementary Notes 11 to 13, in which
regarding housework ability and conversation ability of the customer in the attribute of the customer, a face-to-face format community is extracted from the plurality of communities as the recommended community in a case where the conversation ability is higher than the housework ability, and an online format community is extracted from the plurality of communities as the recommended community in a case where the housework ability is higher than the conversation ability.

### (Supplementary Note 15)

The recommendation method according to any one of Supplementary Notes 11 to 14, in which
the attribute of the customer is a residential area of the customer or regional characteristics or the residential area, and
the recommended community is extracted from the plurality of communities based on ease of access to the community in a region of the residential area.

### (Supplementary Note 16)

The recommendation method according to any one of Supplementary Notes 10 to 15, in which
based on health information including a symptom and a medical history of the customer, a community to which another customer having at least one of a similar symptom and a similar medical history belongs is extracted as the recommended community from the plurality of communities.

### (Supplementary Note 17)

The recommendation method according to any one of Supplementary Notes 10 to 16, in which
a change, from a single-person household to a multi-person household, in the customer who was estimated to have changed to a single-person household is further estimated,
a recommended community for multi-person households is newly extracted from the plurality of communities, and
the newly extracted recommended community is presented.

### (Supplementary Note 18)

The recommendation method according to any one of Supplementary Notes 10 to 17, in which
the product is at least one of food, daily necessities, and clothing items,
the delivery person delivers the product to the customer's home, and
the salesperson is a store clerk who sells the product.

### (Supplementary Note 19)

A program that causes a computer to execute processing including
estimating a change, from a multi-person household to a single-person household, in a customer who is a member based on at least one of a product purchase history of the customer and communication information between a delivery person or a salesperson and the customer,
extracting a recommended community for single-person households from a plurality of communities for the members based on at least one of community information including information indicating an attribute of the community for each of the plurality of communities for the members and an estimation result of a change, to a single-person household, in another customer, and
presenting the extracted recommended community.

### (Supplementary Note 20)

A non-transitory computer-readable recording medium that records a program for causing a computer to executing processing including
estimating a change, from a multi-person household to a single-person household, in a customer who is a member based on at least one of a product purchase history of the customer and communication information between a delivery person or a salesperson and the customer,
extracting a recommended community for single-person households from a plurality of communities for the members based on at least one of community information including information indicating an attribute of the community for each of the plurality of communities for the members and an estimation result of a change, to a single-person household, in another customer, and
presenting the extracted recommended community.

### (Supplementary Note 21)

The recording medium, according to Supplementary Note 20, that records a program for causing a computer to execute processing including
specifying an attribute of the customer based on at least one of the purchase history and the communication information, in which
the extraction means extracts the recommended community from the plurality of communities based on the attribute of the customer.

### (Supplementary Note 22)

The recording medium, according to Supplementary Note 21, that records a program for causing a computer to execute processing including
extracting, from the plurality of communities, a community to which another customer having an attribute similar to the attribute of the customer belongs as the recommended community.

### (Supplementary Note 23)

The recording medium, according to Supplementary Note 21 or 22, that records a program for causing a computer to execute processing including
extracting the recommended community from the plurality of communities based on the attribute of the customer and the format of the community, in which
the community information includes information indicating a format of the community.

### (Supplementary Note 24)

The recording medium, according to any one of Supplementary Notes 21 to 23, that records a program for causing a computer to execute processing including
regarding housework ability and conversation ability of the customer in the attribute of the customer, extracting a face-to-face format community from the plurality of communities as the recommended community in a case where the conversation ability is relatively higher than the housework ability, and extracting an online format community from the plurality of communities as the recommended community in a case where the housework ability is relatively higher than the conversation ability.

### (Supplementary Note 25)

The recording medium, according to any one of Supplementary Notes 21 to 24, that records a program for causing a computer to execute processing including
extracting the recommended community from the plurality of communities based on ease of access to the community in a region of a residential area, in which
the attribute of the customer is a residential area of the customer or regional characteristics or the residential area.

### (Supplementary Note 26)

The recording medium, according to any one of Supplementary Notes 20 to 25, that records a program for causing a computer to execute processing including
based on health information including a symptom and a medical history of the customer, extracting a community to which another customer having at least one of a similar symptom and a similar medical history belongs as the recommended community from the plurality of communities.

### (Supplementary Note 27)

The recording medium, according to any one of Supplementary Notes 20 to 26, that records a program for causing a computer to execute processing including
estimating a change, from a single-person household to a multi-person household, in the customer who was estimated to have changed to a single-person household,
newly extracting a recommended community for multi-person households from the plurality of communities, and
presenting the newly extracted recommended community.

### (Supplementary Note 28)

The recording medium, according to any one of Supplementary Notes 20 to 27, that records a program for causing a computer to execute processing, in which
the product is at least one of food, daily necessities, and clothing items,
the delivery person delivers the product to the customer's home, and
the salesperson is a store clerk who sells the product.

1. A recommendation system comprising:
at least one memory configured to store instructions; and
at least one processor configured to execute the instructions to:
estimate a change, from a multi-person household to a single-person household, in a customer who is a member based on at least one of a product purchase history of the customer and communication information between a delivery person or a salesperson and the customer;
extract a recommended community for single-person households from a plurality of communities for the members based on at least one of community information including information indicating an attribute of the community for each of the plurality of communities for the members and an estimation result of a change, to a single-person household, in another customer; and
present the extracted recommended community.

2. The recommendation system according to claim 1, wherein the at least one processor is further configured to execute the instructions to:
specify an attribute of the customer based on at least one of the purchase history and the communication information; and
extract the recommended community from the plurality of communities based on the attribute of the customer.

3. The recommendation system according to claim 2, wherein the at least one processor is further configured to execute the instructions to:
extract from the plurality of communities, a community to which another customer having an attribute similar to the attribute of the customer belongs as the recommended community.

4. The recommendation system according to claim 2, wherein the at least one processor is further configured to execute the instructions to:
extract the recommended community from the plurality of communities based on the attribute of the customer and a format of the community.

5. The recommendation system according to claim 2, wherein the at least one processor is further configured to execute the instructions to:
extract regarding housework ability and conversation ability of the customer in the attribute of the customer, a face-to-face format community from the plurality of communities as the recommended community in a case where the conversation ability is higher than the housework ability; and
extract an online format community from the plurality of communities as the recommended community in a case where the housework ability is higher than the conversation ability.

6. The recommendation system according to claim 2, wherein the attribute of the customer is a residential area of the customer or regional characteristics or the residential area, and the at least one processor is further configured to execute the instructions to:
extract the recommended community from the plurality of communities based on ease of access to the community in a region of the residential area.

7. The recommendation system according to claim 1, wherein the at least one processor is further configured to execute the instructions to:
extract, based on health information including a symptom and a medical history of the customer, a community to which another customer having at least one of a similar symptom and a similar medical history belongs as the recommended community from the plurality of communities.

8. The recommendation system according to claim 1, wherein the at least one processor is further configured to execute the instructions to:
estimate a change, from a single-person household to a multi-person household, in the customer who was estimated to have changed to a single-person household;
newly extract a recommended community for multi-person households from the plurality of communities; and
present the newly extracted recommended community.

9. The recommendation system according to claim 1, wherein
the product is at least one of food, daily necessities, and clothing items,
the delivery person delivers the product to the customer's home, and
the salesperson is a store clerk who sells the product.

10. A recommendation method comprising:
estimating a change, from a multi-person household to a single-person household, in a customer who is a member based on at least one of a product purchase history of the customer and communication information between a delivery person or a salesperson and the customer;
extracting a recommended community for single-person households from a plurality of communities for the members based on at least one of community information including information indicating an attribute of the community for each of the plurality of communities for the members and an estimation result of a change, to a single-person household, in another customer; and
presenting the extracted recommended community.

11. A non-transitory computer-readable recording medium that records a program for causing a computer to execute:
estimating a change, from a multi-person household to a single-person household, in a customer who is a member based on at least one of a product purchase history of the customer and communication information between a delivery person or a salesperson and the customer,
extracting a recommended community for single-person households from a plurality of communities for the members based on at least one of community information including information indicating an attribute of the community for each of the plurality of communities for the members and an estimation result of a change, to a single-person household, in another customer, and
presenting the extracted recommended community.
